(19) United States
(12) Patent Application Publication
(10) Pub. No.: US 2012/0089736 A1
(43) Pub. Date: Apr. 12, 2012

(54) APPARATUS AND METHOD FOR CONTROLLING COMPUTING CAPACITY FOR MULTIPLE COMPUTERS SHARING RESOURCES WITH EACH OTHER

(75) Inventors: Kilhwan Kim, Daejeon-si (KR); Hyun Joo Bae, Daejeon-si (KR); Byung Sun Lee, Daejeon-si (KR)

(73) Assignee: Electronics and Telecommunications Research Institute, Daejeon (KR)

(21) Appl. No.: 13/268,801

(22) Filed: Oct. 7, 2011

(30) Foreign Application Priority Data
Oct. 8, 2010 (KR) 10-2010-0098454
Mar. 3, 2011 (KR) 10-2011-0019159

(51) Int. Cl. G06F 15/173

(52) U.S. Cl. 709/226

(57) ABSTRACT

A method and an apparatus for controlling a computing capacity are provided. The method includes: receiving a computing resource deposit request signal from a first computer; determining appropriateness of the computing resource deposit request signal; allocating computing resources deposited by the first computer to a second computer when the computing resource deposit request signal is appropriate; and storing information on the computing resources deposited by the first computer and the computing resources allocated to the second computer in accounts for the first and second computers.

### CROSS-REFERENCE TO RELATED APPLICATIONS

This application claims the benefit of priority Korean Patent Application No. 10-2010-0098454 filed on Oct. 8, 2010 and Korean Patent Application No. 10-2011-0019159 filed on Mar. 3, 2011 which are incorporated by reference in their entirety to herein.

### BACKGROUND OF THE INVENTION

1. Field of the invention

The present invention relates to an apparatus and a method for controlling a computing capacity for multiple computers sharing resources with each other, and more particularly, to an apparatus and a method for controlling a computing capacity capable of configuring a cloud computing environment

2. Related Art

Recently, it has been expected that the use of cloud computing in a number of public and industrial fields will rapidly increase. The cloud computing is a technology of integrating and providing resources of computers present at different physical positions using a virtualization technology. A maximum advantage of the cloud computing is that a computing capacity may be rapidly controlled without investing in separate assets. For example, in the case of enterprises providing a specific service to the outside, the required computing capacity may be frequently changed due to a change in customers behavioral patterns, seasonal factors, and the like. For these enterprises a cloud computing service may become a significant effective method for utilizing computing resources .

However, the cloud computing service (for example, EC2 of Amazon Co., Azure of Microsoft Corporation, or the like) according to the related art has used a scheme in which a single cloud computing service provider provides a cloud computing service to multiple users.

In this scheme, since cloud computing service users entirely depend on the cloud computing service provider for all computing services, the users getting used to owning computing resources feel the loss of independent control rights for the computing to resources, security concerns, or the like.

In addition, the majority of enterprises or organizations have already owned many computing resources. A need exists for a method and an apparatus capable of efficiently utilizing these computing resources even in a cloud computing environment.

Meanwhile, there is a grid computing scheme in which several computers loosely shares computing capacities cooperatively with each other, unlike the cloud computing service that entirely depends on the computing service provider. In the grid computing scheme, owners of each computing resource that participate in grid computing may share their computing resources with each other, if needed, while owning the computing resources.

However, in the case of the grid computing scheme, how many computing resources a single computer resource owner may uses at a specific point in time may not be ensured, due to the loose cooperation relationship between computers (or between computer resource owners). Therefore, there is a limitation in using the grid computing scheme for a service that should satisfy business requirement.

Particularly, distribution and control of computing capacities in the grid computing are made only in consideration of a work request predicted at the present point in time and the present situation of available resources. However, when the distribution of computing resources in a business environment is determined, the future available computing capacity should be able to be predicted according to the past computing resource contribution.

Therefore, a need exists for a method and an apparatus for controlling computing resources capable of ensuring the computing resources that the respective computer organizations may use at a specific point of time as in the cloud computing service while cooperatively sharing the computing resources with each other in a state in which they secure ownership for computing resources as in grid computing.

### SUMMARY OF THE INVENTION

The present invention provides a method and an apparatus for controlling a computing capacity capable of controlling available computing capacities for each computer based on its currently required computing capacity and its historical contribution to sharing computing resource between multiple computers sharing computing resources with each other.

In an aspect, there is provided a method for controlling a computing capacity for multiple computers sharing resources with each other, the method including: receiving a computing resource deposit request signal from a first computer; determining appropriateness of the computing resource deposit request signal; allocating computing resources deposited by the first computer to a second computer when the computing resource deposit request signal is appropriate; and storing information on the computing resources deposited by the first computer and the computing resources allocated to the second computer in accounts for the first and second computers.

The method may further include: receiving a computing resource withdrawal request signal from the first computer; determining appropriateness of the computing resource withdrawal request signal; and allocating computing resources of a third computer to the first computer when the computing resource withdrawal request signal is appropriate.

The computing resource withdrawal request signal may include information on a scale and a time of computing resources for which the first computer requests other computers for permission for use.

The method may further include storing information on the computing resources allocated to the first computer in accounts for the first and third computers.

The third computer may be a computer different from the second computer or be the same computer as the second computer.

In the determining of the appropriateness of the computing resource withdrawal request signal, the appropriateness of the computing resource withdrawal request signal may be determined by comparing a scale of computing resources previously deposited by the first computer with a scale of computing resources for which the first computer requests other computers for permission for use.

The method may further include transmitting a signal requesting correction for a computing resource withdrawal request to the first computer when the computing resource withdrawal request signal is inappropriate.

The method may further include transmitting a signal requesting correction for a computing resource deposit request to the first computer when the computing resource deposit request signal is inappropriate.

The computing resource deposit request signal may include information on a scale and a time of computing resources for which the first computer permits other computers to use.

In the determining of the appropriateness of the computing resource deposit request signal, the appropriateness of the computing resource deposit request signal may be determined by comparing a scale and a time of computing resources for which the first computer permits other computers to use with predetermined thresholds.

In another aspect, there is provided an apparatus for controlling a computing capacity, the apparatus including: a request processing unit receiving a computing resource deposit request signal or a computing resource withdrawal request signal from a first computer; a decision making unit determining appropriateness of the computing resource deposit request signal and the computing resource withdrawal request signal; a computing to resource virtual managing unit allocating computing resources deposited by the first computer to other computers or allocating computing resources to the first computer when the computing resource deposit request signal or the computing resource withdrawal request signal is appropriate; and a computing capacity account managing unit managing information on the computing resources of the first computer and the other computers.

The apparatus may further include a computing capacity account database unit storing information on the computing resources in accounts for the first computer and the other computers.

The computing resource deposit request signal may include information on a scale and a time of computing resources for which the first computer permits the other computers to use, and the computing resource withdrawal request signal may include information on a scale and a time of computing resources for which the first computer requests the other computers for permission for use.

The decision making unit may determine the appropriateness of the computing resource withdrawal request signal by comparing a scale of computing resources previously deposited by the first computer with a scale of computing resources for which the first computer requests other computers for permission for use.

The decision making unit may determine the appropriateness of the computing resource deposit request signal by comparing a scale and a time of computing resources for which the first computer permits other computers to use with predetermined thresholds.

When the decision making unit determines that the computing resource withdrawal request signal is inappropriate, the request processing unit may transmit a signal requesting correction for a computing resource withdrawal request to the first computer.

When the decision making unit determines that the computing resource deposit to request signal is inappropriate, the request processing unit may transmit a signal requesting correction for a computing resource deposit request to the first computer.

### BRIEF DESCRIPTION OF THE DRAWINGS

FIG. 1 shows an example in which each computer independently owning computing resources uses the computing resources.

FIG. 2 conceptually shows a method for controlling a computing capacity according to the present invention.

FIG. 3 shows a configuration of an apparatus for controlling a computing capacity according to an embodiment of the present invention.

FIG. 4 shows a method for processing a computing capacity deposit request in the apparatus for controlling a computing capacity.

FIG. 5 shows a method for processing a computing capacity withdrawal request in the apparatus for controlling a computing capacity.

FIG. 6 shows an application of the present invention in a cooperative cloud computing environment.

### DESCRIPTION OF EXEMPLARY EMBODIMENTS

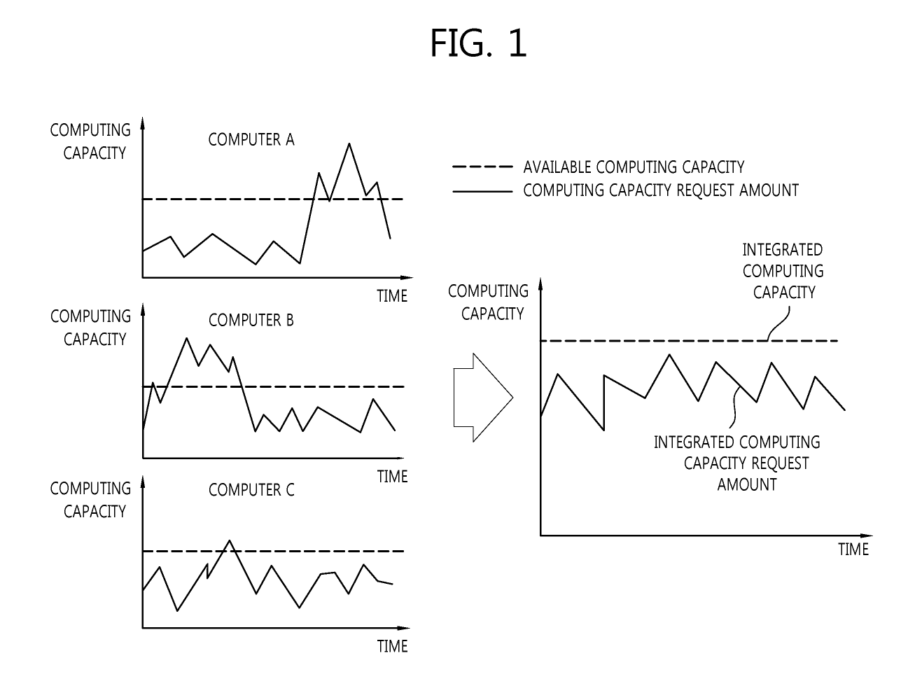

FIG. 1 shows an example in which each computer independently owning computing resources uses the computing resources.

Referring to FIG. 1, computers A, B, and C are computers independently owning computing resources, and may have the same available computing capacity (a measurable value such as a central processing unit (CPU) processing capacity, a memory capacity, or the like). However, time series patterns of computing capacity request amounts during a specific time period may be different. For example, as shown in FIG. 1, in the case of a to computer A, a computing capacity request amount is concentrated for the second half of the specific time period, such that an available computing capacity owned by the computer A may be exceeded. In the case of a computer B, a computing capacity request amount is concentrated for the first half of the specific time period, such that an available computing capacity may be exceeded. In the case of a computer C, a somewhat constant-scale computing capacity request amount may be shown.

In this case, the computer C may perform a smooth computing work; however, the computers A and B are subjected to severe delay in a computing work at a specific time, that is, a specific time in which a computing capacity request amount is larger than their computing capacities.

That is, in some cases, the request for a computing capacity exceeding computing capacities owned by each computer may be generated in each computer. In these cases, delay may be generated in a computing work. In order to solve this problem, computing capacities that each computer independently owns may be increased, which is inefficient in view of a cost and causes a waste in view of resource use.

However, when it is assumed that computing capacities and computing capacity request amounts for the computers A, B, and C are integrated and operated, the probability that the integrated computing capacity request amount for the computers A, B, and C will be temporally smoothed as compared to a computing capacity request amount for a single computer and the probability that the integrated computing capacity request amount will become an amount less than the integrated computing capacity increase. Therefore, the probability that a smooth computing work will be secured over all of time periods in the computers A, B, and C increases.

Although FIG. 1 shows only three computers for convenience of explanation, when computing capacity request amounts for more computers are integrated, the to probability that the integrated computing capacity request amount will be temporally smoothed significantly increases by ‘the law of large number’.

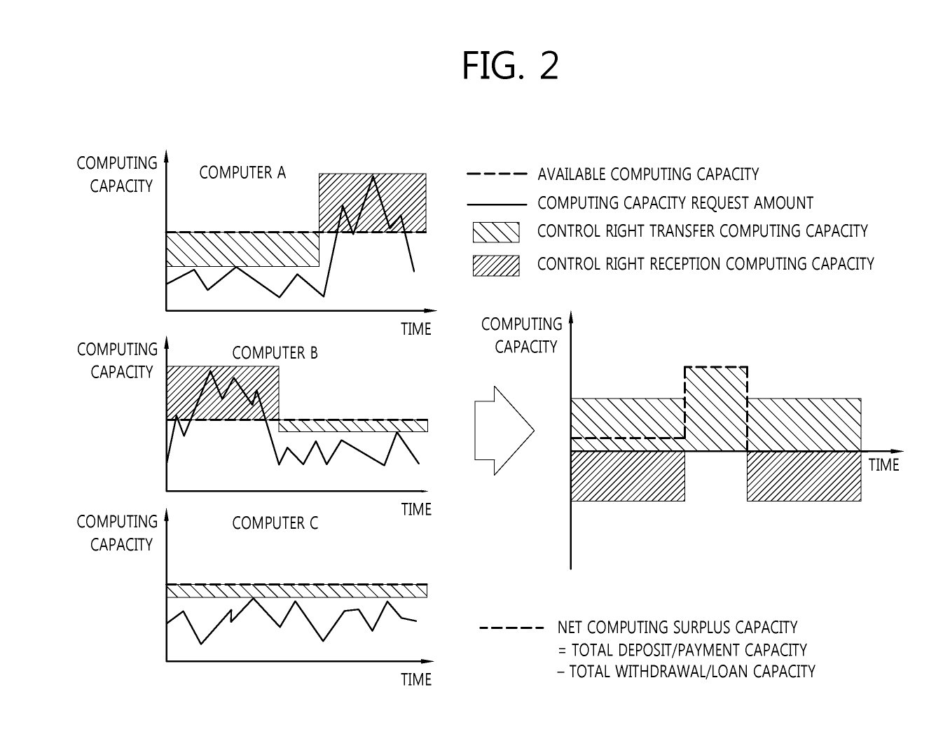

FIG. 2 conceptually shows a method for controlling a computing capacity according to the present invention.

Referring to FIG. 2, a computer A transfers a control right for a partial computing capacity to any other computers so that any other computers may use a surplus computing capacity (called a control right transfer computing capacity) during a period in which a computing capacity less than an available computing capacity is required, and receives and uses control rights for computing capacities (called control right reception computing capacities) for any other computers during a period in which a computing capacity exceeding an owned computing capacity is required.

Likewise, a computer B receives and uses control rights for computing capacities for other computers during a period in which a computing capacity request amount is concentrated. In addition, the computer B transfers a control right for a computing capacity as much as the computing capacity that it uses, during a period in which a computing capacity request amount is reduced.

In an environment in which multiple computers are connected to each other, a specific computer explicitly declares a period in which and a magnitude at which other computers may use a portion of a surplus computing capacity except for a required computing capacity in a computing capacity and then transfers a control right to other computers so that other computers may use the portion of the surplus computing capacity, which will be, hereinafter, called deposit (or payment) of a computing capacity for convenience.

A specific computer explicitly declares a use period and a magnitude of a computing capacity and then receives control rights for computing capacities from other to computers, which will be called withdrawal (or loan) of a computing capacity for convenience.

In addition, a computing capacity obtained by performing summation using a computing capacity deposited by a specific computer as a positive value and using a computing capacity withdrawn by the specific computer as a negative value is called the balance of a computing capacity for the computer.

The reason why the use and the magnitude of the computing capacity are explicitly declared to deposit/withdraw the computing capacity and manage the balance of the computing capacity is to allow a current computing resource use amount to be determinable according to the past computing capacity sharing contribution of each computer simultaneously with allowing computing capacities that each computer may use at a predetermined point in time to be predictable.

In order to implement a process of depositing/withdrawing the computing capacity and managing the balance, an apparatus and a method capable of processing deposit/withdrawal requests of computers owning the computing resources and virtually distributing the computing resources to each computer are required.

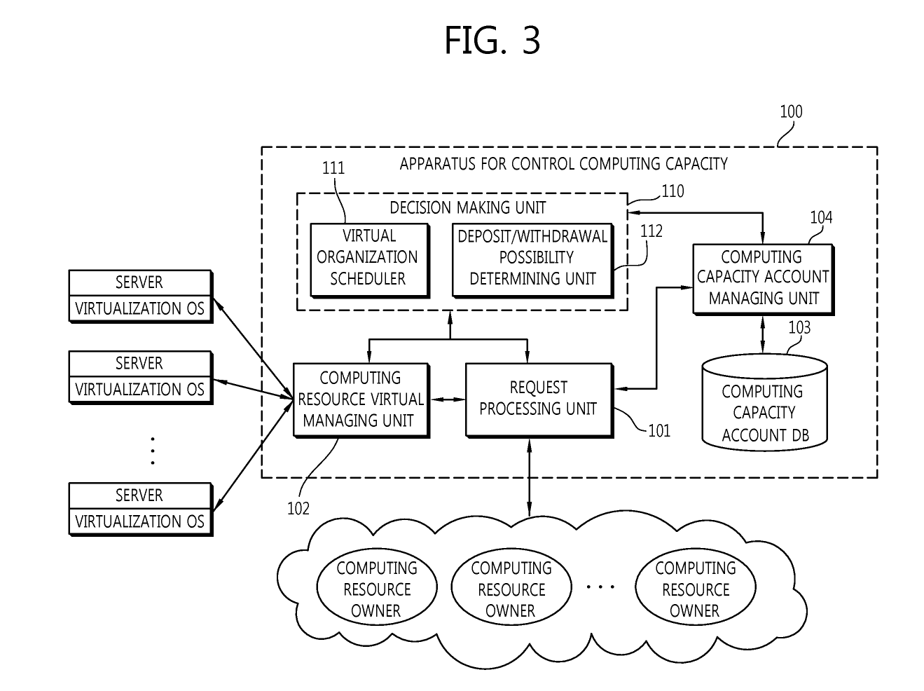

FIG. 3 shows a configuration of an apparatus for controlling a computing capacity according to an embodiment of the present invention.

Referring to FIG. 3, the apparatus 100 for controlling a computing capacity may include a request processing unit 101, a computing resource virtual managing unit 102, a decision making unit 110, a computing capacity account managing unit 104, and a computing capacity account database (DB) 103.

The request processing unit 101 is a module receiving a computing capacity deposit or withdrawal request signal from individual computers (or automated software installed in the individual computers) and transferring a result thereof to the computing resource virtual managing unit 102 and the decision making unit 110. Here, the individual computers may be called computing resource owners.

The decision making unit 110 is a module receiving the computing capacity deposit or withdrawal request signal from the request processing unit 110 and determining the possibility of deposit or withdrawal of the computing capacity for the computer performing a corresponding request.

The decision making unit 110 may include a virtual organization scheduler 111 and a deposit/withdrawal possibility determining unit 112. The virtual organization scheduler 111 searches for virtual organization alternatives for each time zones of computing resources satisfying already progressing or newly generated computing capacity deposit or withdrawal requests of each computer and determines the optimal virtual organization.

The deposit/withdrawal possibility determining unit 112 determines whether or not the deposit or withdrawal of the computing capacity is approved by comparing the computing capacity deposit or withdrawal request with the balance of a computing capacity account for the computing resource owner. That is, the computing capacities that each computer may use at a predetermined point in time may be determined by the deposit/withdrawal possibility determining unit 112 according to the past computing capacity sharing contributions of each computer.

The computing resource virtual managing unit 102 is a module distributing and controlling the computing resources to a server having a virtualization operation system (OS) according to the deposit or withdrawal determination of the decision making unit 110. Here, the server may be recognized as a device within the individual computers or connected to the individual computers by the virtualization OS in view of a user, and the user may perform a desired computing work through the server.

The computing capacity account managing unit 104 is a module managing the balance of an account according to the computing capacity deposit, the computing capacity withdrawal, or the like, of the computing resource owners. That is, the respective computing resource owners may have their unique accounts, and the computing capacity account managing unit 104 may manage the computing capacities deposited (paid) or withdrawn (loaned) by the computing resource owners.

The computing capacity account DB 103 is a memory storing a computing capacity account therein. Information such as IDs unique to each computer, the balance of the computing capacities according to the deposit or withdrawal results may be stored in the computing capacity account DB.

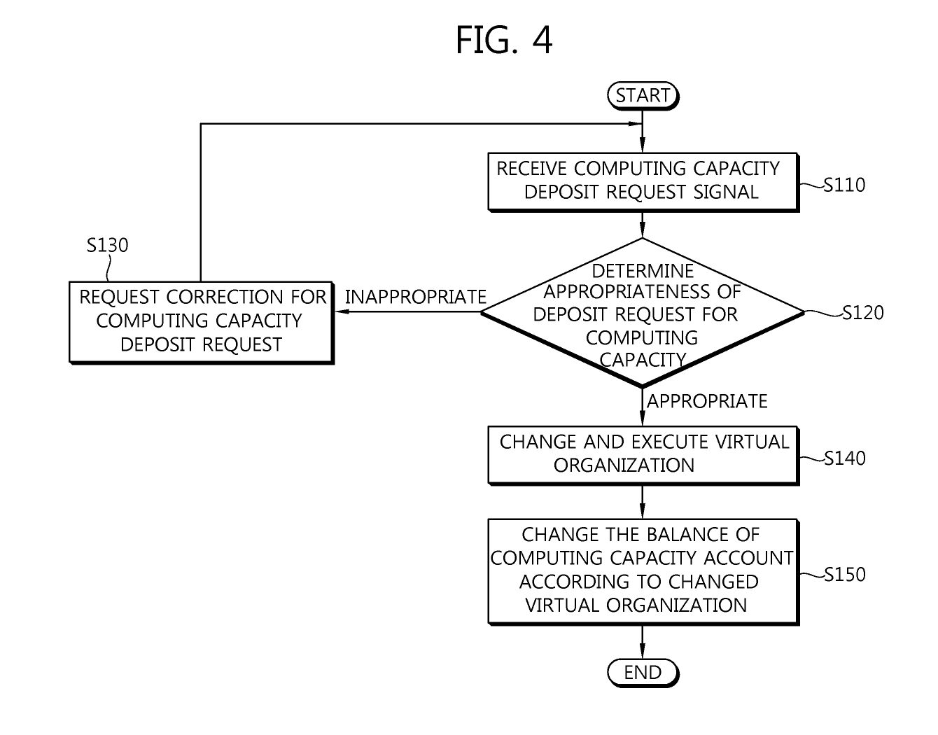

FIG. 4 shows a method for processing a computing capacity deposit request in the apparatus for controlling a computing capacity.

Referring to FIG. 4, the request processing unit 101 receives a computing capacity deposit request signal (S110). The deposit request signal may include IDs, scales of deposited computing capacities, and information on deposit times of computers. The request processing unit 101 transfers the computing capacity deposit request signal to the decision making unit 110.

The decision making unit 110 determines appropriateness of the deposit request for a computing capacity (S120). For example, the decision making unit 110 may determine the appropriateness of the deposit request for a computing capacity by comparing information on the deposited computing capacity with a predetermined threshold. For example, in the case in which a deposit time permitting the use of a control right for a memory of the computer A is shorter than a threshold or a deposited memory capacity is smaller than a threshold in a computing capacity for which the computer A requests the deposit, the decision making unit 110 may reject the deposit request. In this case, when the deposit request is permitted, a frequent change in virtual organization is required. Therefore, the deposit/withdrawal possibility determining unit 112 of the decision making unit 110 may compare a deposit computing capacity scale and a deposit period with predetermined thresholds and determine that the deposit request is appropriate only in the case in which the deposit computing capacity scale and the deposit period are larger than the thresholds. The permitted threshold of the deposit time or the computing capacity scale may be set as a predetermined value or be defined as a value varied depending on circumstances.

When the deposit/withdrawal possibility determining unit 112 determines that the deposit request is inappropriate, the request processing unit 101 transmits a computing capacity deposit request correction signal to the computer requesting the deposit(S130).

When the deposit/withdrawal possibility determining unit 112 determines that the deposit request is appropriate, it transfers the deposit request signal to the virtual organization scheduler 111, and the virtual organization scheduler 111 controls the future virtual organization scheduling so that other computers may use the computing capacity for the computer requesting the deposit. The computing resource virtual managing unit 102 changes and executes the virtual organization by allocating computing resources to each server according to the virtual organization scheduling through a virtualization OS of the server (S140).

The computing capacity account managing unit 104 changes the balance of the computing capacity account according to the changed virtual organization (S150). For example, when the computer A deposits a computing capacity M and the computer B loans the computing capacity M, this information is stored and updated in computing capacity accounts for each of the computers A and B to thereby change the balance of the computing capacity account.

That is, information on the computing capacity contributed (deposited or paid) by a specific computer in the past, the computing capacity used (withdrawn or loaned) by the specific computer in the past, or the like, is stored and managed in a computing capacity account for the specific computer.

The total amount of deposit for the computing resources may rapidly increase with the passage of time. In order to prevent the rapid increase in the total amount of deposit for the computing resources, the computing capacity deposited by the specific computer may be set so as not to exceed a specific value even with the infinite passage of time. For example, when the computer A continuously deposits a computing capacity C, an interest rate α (α<1) is applied, and the total amount of the deposited computing capacity may be set so as not to exceed C/(1-α) even with the infinite passage of time.

This means that a value for the future available computing capacity is significantly larger than a value for the past available computing capacity.

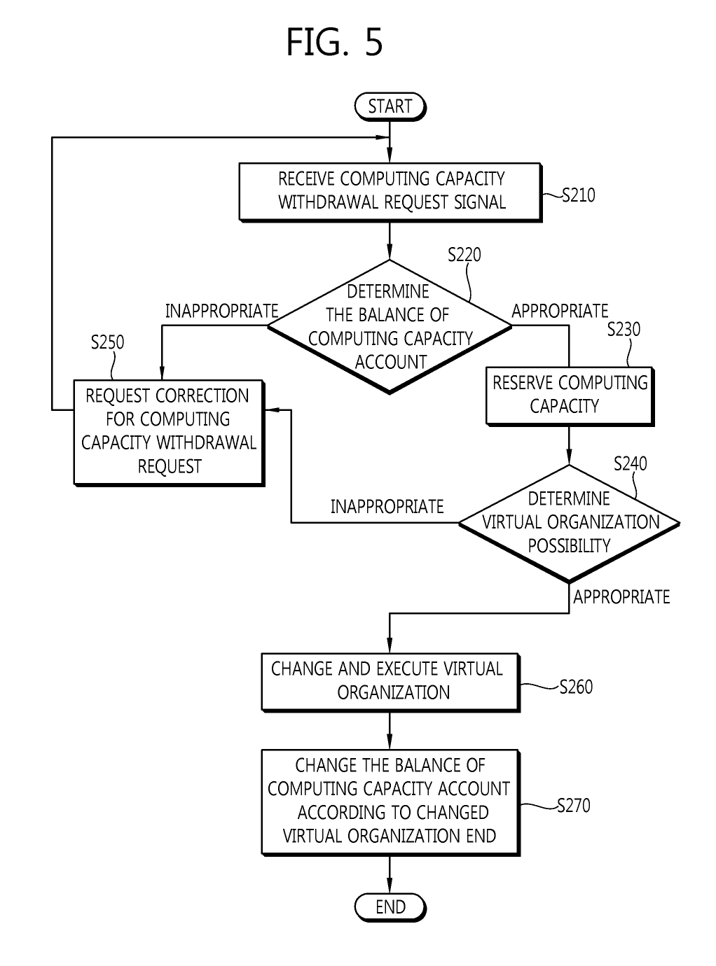

FIG. 5 shows a method for processing computing capacity withdrawal request in the apparatus for controlling a computing capacity.

Referring to FIG. 5, the request processing unit 101 receives a computing capacity withdrawal request signal (S210). The withdrawal request signal may include information on IDs, information on computing capacities, and information on withdrawal times of individual computers. Then, the request processing unit 101 transfers the withdrawal request signal to the decision making unit 110.

The deposit/withdrawal possibility determining unit 112 of the decision making unit 110 requests the computing capacity account managing unit 140 for the balance of a computing capacity account for a computer performing withdrawal request, receives the balance of the computing capacity account for the computer performing withdrawal request, and determines whether or not the balance of the computing capacity account is sufficient for processing the withdrawal request (S220).

For example, when the balance of the computing capacity account is insufficient, that is, when the withdrawal request is inappropriate due to a withdrawal request scale significantly larger as compared to the balance of the computing capacity account, correction for the computing capacity withdrawal request is requested (S250). That is, the request processing unit 101 transmits a correction signal for a computing capacity withdrawal scale or a withdrawal time to the computer performing withdrawal request.

With respect to withdrawal request for which the balance of the computing capacity account is sufficient, withdrawal reservation for the balance of the computing capacity for the computer account is first performed in order to prevent double withdrawal of computing resources (S230). Information on the computing resources for which the withdrawal is reserved is transferred to the virtual organization scheduler 111, such that virtual organization scheduling is controlled (S240). The computing resource virtual managing unit 102 changes and executes the virtual organization of each server by allocating computing resources according to the virtual organization scheduling through a virtualization OS of the related server. That is, the present invention is different from the related art in that when a specific computer requests other computers for computing capacities in an environment in which multiples computers are connected to each other, appropriateness of a corresponding request may be determined based on the past computing capacity contribution of the specific computer.

The computing capacity account managing unit 104 changes the balance of the computing capacity account according to the changed virtual organization (S270).

In the method for controlling a computing capacity described above with reference to FIGS. 4 and 5, the deposit/withdrawal of the computing capacity has been described by way of example. However, a process of processing loan of a computing capacity may also be performed in the same scheme as the process of processing the withdrawal of the computing capacity. For example, whether or not a loan request for a computing capacity is appropriate may be determined according to the past computing capacity contribution of a computer performing the request or be determined based on a predetermined computing capacity threshold. In addition, a process of processing payment of a computing capacity may be performed in the same scheme as the process of processing the deposit of the computing capacity. Appropriateness of a payment request for a computing capacity may be determined based on a predetermined computing capacity threshold.

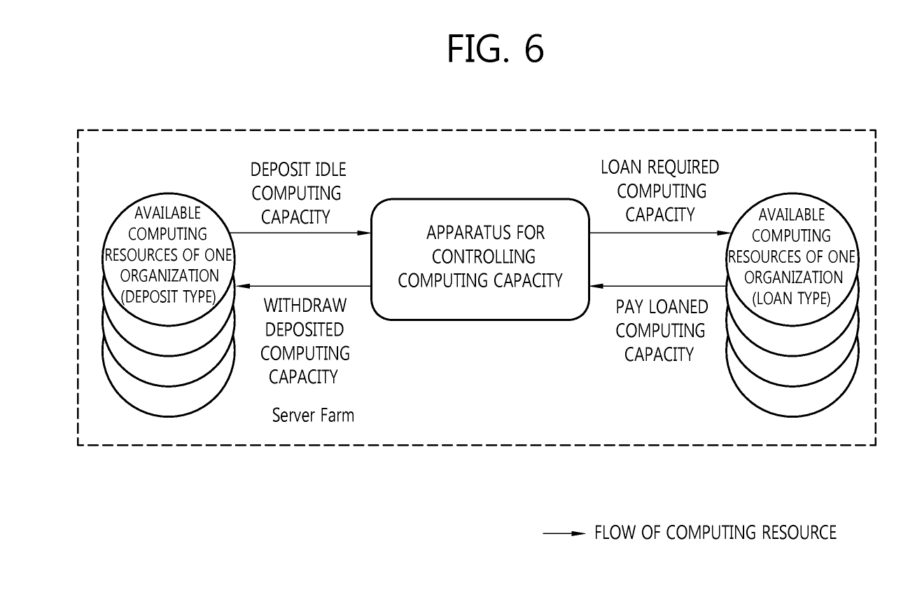

FIG. 6 shows an application of the present invention in a cooperative cloud computing environment.

Referring to FIG. 6, computing resources owned by several organizations is configured as a single logical server farm in a distributed space in which congestion of communication between computing resources is not largely problematic or in the physically same space such as the Internet data center (IDC). The computing resources of each organization may be configured as a single computing server or a group of several computing servers.

The computing resources of each organization may be connected to the apparatus for controlling a computing capacity to thereby request deposit/payment for an idle computing capacity or increase or decrease a virtual available computing capacity through withdrawal/loan, or the like, for a computing capacity request amount.

According to the present invention, after an idle computing capacity for one organization is explicitly deposited during a specific period to thereby allow other organizations to use the deposited computing capacity, a computing capacity as much as the deposited computing capacity may be withdrawn and used at a specific point of time. to Alternatively, after an exceeded computing capacity required in one organization is explicitly loaned and used from computing capacities for other organizations, the computing capacity loaned during a specific period may be paid so that it may be used by users of other organizations.

With the method for controlling a computing capacity according to the present invention, each computer may premeditatedly cope with a change in a computing capacity while owning ownership for computing resources. In addition, idle computing capacities for each organization that are not used to thereby be volatilized and discarded may be used, such that the entire efficiency in the use of the resources increases.

That is, it is possible to implement a cooperative cloud computing environment allowing several organizations that have trust relationship to rapidly extend a computing capacity, if needed, as in a cloud computing environment without losing a control right for their computing resources through cooperation.

With the apparatus and the method for controlling a computing capacity according to the present invention, it is possible to configure a cooperative cloud computing environment. Therefore, each computer may premeditatedly cope with a change in a computing capacity while owning ownership for computing resources. In addition, idle computing capacities for each computer that are not used to thereby be volatilized and discarded may be used, such that the entire efficiency in the use of the resources increases.

Although the present invention has been described with reference to the embodiment, those skilled in the art will appreciate that various modifications and alterations may be made without departing from the scope and spirit of the invention. Therefore, the present invention is not limited to the above-mentioned embodiment but is intended to include all embodiments falling within the scope defined in the following claims.

What is claimed is:

1. A method for controlling a computing capacity for multiple computers sharing resources with each other, the method comprising:
receiving a computing resource deposit request signal from a first computer;
determining appropriateness of the computing resource deposit request signal;
allocating computing resources deposited by the first computer to a second computer when the computing resource deposit request signal is appropriate; and
storing information on the computing resources deposited by the first computer and the computing resources allocated to the second computer in accounts for the first and to second computers.

2. The method of claim 1, further comprising:
receiving a computing resource withdrawal request signal from the first computer;
determining appropriateness of the computing resource withdrawal request signal; and
allocating computing resources of a third computer to the first computer when the computing resource withdrawal request signal is appropriate.

3. The method of claim 2, wherein the computing resource withdrawal request signal includes information on a scale and a time of computing resources for which the first computer requests other computers for permission for use.

4. The method of claim 2, further comprising storing information on the computing resources allocated to the first computer in accounts for the first and third computers.

5. The method of claim 4, wherein the third computer is a computer different from the second computer.

6. The method of claim 4, wherein the third computer is the same computer as the second computer.

7. The method of claim 4, wherein in the determining of the appropriateness of the computing resource withdrawal request signal, the appropriateness of the computing to resource withdrawal request signal is determined by comparing a scale of computing resources previously deposited by the first computer with a scale of computing resources for which the first computer requests other computers for permission for use.

8. The method of claim 2, further comprising transmitting a signal requesting correction for a computing resource withdrawal request to the first computer when the computing resource withdrawal request signal is inappropriate.

9. The method of claim 1, further comprising transmitting a signal requesting correction for a computing resource deposit request to the first computer when the computing resource deposit request signal is inappropriate.

10. The method of claim 1, wherein the computing resource deposit request signal includes information on a scale and a time of computing resources for which the first computer permits other computers to use.

11. The method of claim 1, wherein in the determining of the appropriateness of the computing resource deposit request signal, the appropriateness of the computing resource deposit request signal is determined by comparing a scale and a time of computing resources for which the first computer permits other computers to use with predetermined thresholds.

12. An apparatus for controlling a computing capacity, the apparatus comprising:
a request processing unit receiving a computing resource deposit request signal or a computing resource withdrawal request signal from a first computer;
a decision making unit determining appropriateness of the computing resource deposit request signal or the computing resource withdrawal request signal;
a computing resource virtual managing unit allocating computing resources deposited by the first computer to other computers or allocating computing resources to the first computer when the computing resource deposit request signal or the computing resource withdrawal request signal is appropriate; and
a computing capacity account managing unit managing information on the computing resources of the first computer and the other computers.

13. The apparatus of claim 12, further comprising a computing capacity account database unit storing information on the computing resources in accounts for the first computer and the other computers.

14. The apparatus of claim 12, wherein the computing resource deposit request signal includes information on a scale and a time of computing resources for which the first computer permits the other computers to use.

15. The apparatus of claim 12, wherein the computing resource withdrawal request signal includes information on a scale and a time of computing resources for which the first computer requests the other computers for permission for use.

16. The apparatus of claim 12, wherein the decision making unit determines the appropriateness of the computing resource withdrawal request signal by comparing a scale of computing resources previously deposited by the first computer with a scale of computing resources for which the first computer requests other computers for permission for use.

17. The apparatus of claim 12, wherein the decision making unit determines the appropriateness of the computing resource deposit request signal by comparing a scale and a time of computing resources for which the first computer permits other computers to use with predetermined thresholds.

18. The apparatus of claim 12, wherein when the decision making unit determines that the computing resource withdrawal request signal is inappropriate, the request processing unit transmits a signal requesting correction for a computing resource withdrawal request to the first computer.

19. The apparatus of claim 12, wherein when the decision making unit determines that the computing resource deposit request signal is inappropriate, the request processing unit transmits a signal requesting correction for a computing resource deposit request to the first computer.
